(19) United States
(12) Patent Application Publication
(10) Pub. No.: US 2014/0104912 A1
(43) Pub. Date: Apr. 17, 2014

(54) WATER COOLING SUB-HIGH FREQUENCY TRANSFORMER AND COOLING DEVICE THEREOF

(71) Applicant: SHENZHEN HONGBAI TECHNOLOGY INDUSTRIAL CO., LTD, Shenzhen (CN)

(72) Inventors: Yuqi Han, Shenzhen (CN); Zhiwei Chen, Shenzhen (CN); Ping Xiong, Shenzhen (CN); Peiwen Han, Shenzhen (CN); Jingyu Chen, Shenzhen (CN)

(73) Assignee: SHENZHEN HONGBAI TECHNOLOGY INDUSTRAIL CO., LTD, Shenzhen (CN)

(21) Appl. No.: 14/119,923

(22) PCT Filed: Jun. 8, 2011
(86) PCT No.: PCT/CN2011/075454

§ 371 Date: Nov. 25, 2013

(51) Int. Cl. H01F 27/16

(52) U.S. Cl. CPC H01F 27/16
USPC 363/141

(57) ABSTRACT

A sub-high frequency transformer with water-cooled heat dissipation includes a magnetic core (8), primary coils (10), secondary coils (9a1, 9a2, 9b1, 9b2, 9c1, 9c2, 9d1, 9d2), secondary leading terminals of the transformer, and a rectifying tube circuit connected with the secondary leading terminals of the transformer. The rectifying tube circuit includes plane-type rectifying diodes (11, 12), positive leading plates (3, 4, 5, 6) of the diodes, a rectifier positive output plate (2), and a rectifier negative output plate (1) which is also the central tap of the transformer. A secondary current of the transformer, after being rectified by the plane-type rectifying diodes, is connected to and is output from the rectifier positive output plate. The positive leading plates of the plane-type rectifying diode, the rectifier positive output plate and the rectifier negative output plate have a copper plate structure with a certain thickness and having water passages for heat dissipation inside.

### TECHNICAL FIELD

The present invention relates to a transformer, particularly to a high frequency transformer for spot welders.

### BACKGROUND ART

Traditional resistance welding power sources mainly include AC/DC power frequency spot welders controlling a welding current by adjusting the SCR conduction angle, which are technically mature but bulky. As single-phase input power sources, they are limited by high energy consumption, low efficiency, poor dynamic performance as well as low control accuracy.

In the eighties and nineties, intermediate frequency inverter resistance welding emerges, single-phase power supply upgraded to three-phase power supply and transformer operating frequency elevated from 50 HZ to 1000 HZ. An intermediate frequency resistance welding machine has a much smaller size and a promoted efficiency. A DC power intermediate frequency resistance welding machine has a remarkably improved welding efficiency in comparison with an AC power spot welder, saving energy by 60%-70%, but still is quite big and heavy. A sub-high frequency inverter spot welder further improves the transformer efficiency (to 5,00˜20,000 HZ) and reduces its size and weight on the basis of the intermediate frequency spot welder. It also has better dynamic response, higher control accuracy and smaller size than an intermediate frequency spot welder.

The inventor has found said traditional high frequency transformer unsatisfactory in that it has cooling difficulties, by reason of which the temperature rises notably as output power increases, and the rectifier diode is prone to damages, making it hard to further improve the output power. For a suspension spot welder, the inverse transformer in the prior art is bulky and inefficient, unable to meet its requirements of large current and high power.

### DISCLOSURE OF THE INVENTION

The primary object of this invention is to improve transformer output power and reduce its temperature rise at the same time.

The second object of the present invention is to improve transformer output power and reduce its size at the same time.

The invention discloses the following solutions: a water cooling sub-high frequency transformer comprises a magnetic core, a primary coil, a secondary coil, a transformer secondary lead terminal, and a rectifier circuit connected with the transformer secondary lead terminal, characterized in that the rectifier circuit comprises a planar rectifier diode, a diode positive terminal lead plate, a rectifier cathode output plate, and a rectifier anode output plate, wherein the rectifier cathode output plate is a center tap of the transformer; the secondary current of the transformer is connected to the rectifier anode output plate after being rectified by the planar rectifier diode, and is output by the rectifier anode output plate; and each of the rectifier diode positive lead plate, the rectifier anode output plate and the rectifier cathode output plate employs a copper plate structure with a certain thickness provided inside with cooling water passages.

The water cooling sub-high frequency transformer comprises two sub transformers connected in parallel, each comprising one to three groups of primary coils and one to three groups of secondary coils; each group of primary coils comprises three sub coils, and each group of secondary coils comprises two secondary coils each of which has its two ends joined together; the two leads for the respective two ends of each secondary coil are respectively connected to two diode positive terminal lead plates parallel in a vertical direction; the secondary coil center tap terminal is connected to the rectifier cathode output plate at the joining parts of two secondary coils; the two diode positive terminal lead plates are connected with the positive terminals of the planar rectifier diodes, and the negative terminals are connected with the rectifier anode output plate positioned between the two diode positive terminal lead plates, one planar rectifier diode being positioned between the upper diode positive terminal lead plate and the rectifier anode output plate and the other planar rectifier diode being positioned between the lower diode positive terminal lead plate and the rectifier anode output plate, so that the two planar rectifier diodes are tightly pressed between three copper plates: the two diode positive terminal lead plates and the rectifier anode output plate.

The secondary coil is winded with a red copper pipe of a 4˜10 mm diameter in communication with the cooling water passages in the rectifier diode positive lead plate, the rectifier anode output plate and the rectifier cathode output plate.

The secondary coil center tap terminal of the sub transformer is welded to the rectifier cathode output plate, wherein two output terminals are welded to the upper diode positive terminal lead plate and the other two output terminals are welded to the lower diode positive terminal lead plate.

The diode positive terminal lead plate, the rectifier cathode output plate and the rectifier anode output plate respectively employ a plate structure made of a red copper plate with a thickness of 10˜15 mm, wherein through holes provided within each plate structure compose cooling water passages for cooling water circulation flow, and theses cooling water passages communicate with the red copper pipes composing the secondary coils.

A cooling device comprises a water outlet, a water inlet and cooling water passages in communication with each other, characterized in that the water inlet is provided on the rectifier cathode output plate, the water outlet is provided on the rectifier anode output plate, and the cooling water passages are provided inside the rectifier cathode output plate, the rectifier anode output plate and diode positive terminal lead plate, wherein the rectifier cathode output plate, the rectifier anode output plate and the diode positive terminal lead plate respectively employ a plate structure with a certain thickness, a plurality of through holes are provided inside each of the plate structure to compose cooling water passages for cooling water circulation flow, and theses cooling water passages communicate with red copper pipes that compose transformer secondary coils.

In the water cooling workflow of the cooling device, the cooling water flows from the water inlet on the rectifier cathode output plate into the cooling water passages on the same plate before diverging into three to six streams: two of the separated streams flow out of the cooling water passages on the rectifier cathode plate to enter the cooling water passages on the rectifier anode output plate and then converge at the outlet of the same plate; and, the rest of streams flow out of the cooling water passages on the rectifier cathode plate to enter one group of the cooling water passages on the planar rectifier diode positive plate, get into another group of the cooling water passages on the planar rectifier diode positive plate after separating two of them to get into two or three secondary coils, and afterwards flow into the cooling water passages on the rectifier anode output plate to finally converge at the water outlet on the same plate.

In a water cooling workflow of the cooling device, the cooling water flows from the water inlet on the rectifier cathode output plate into the cooling water passages on the same plate before being separated by said passages into four branches A, B, C and D in parallel connection, flow into the cooling water passages on the rectifier anode output plate and then converge at the water outlet on the same plate to flow out.

The water passages and conduits in the water cooling device are connected with each other by an insulating rubber tube with a self-locking connector comprising a self-lock head and a self-lock sleeve with an inner diameter smaller than the outer diameter of the rubber tube stretched after being inserted into the self-lock head, and the engaging part between the self-lock head and the rubber tube is provided with two inverted cone slots with acute angle openings, a partially engaging cylindrical surface provided between the slots has an inner diameter larger than that of the rubber tube.

The present invention has advantages effects as follows:

Firstly, using planar rectifier diodes helps to minimize the required rectifier diode quantity and thereby remarkably reduce the transformer size. Four planar rectifier diodes are enough for outputting a current of 12000 A.

Secondly, the diode positive terminal lead terminal, the rectifier anode output terminal and the rectifier cathode terminal respectively adopt a cooper plate structure with a certain thickness provided inside with cooling water passages, and the two planar rectifier diodes are tightly pressed between those three copper plates. In this way, tight contact between the copper plates and the diodes, as well as efficient transfer of current and heat, can be ensured.

Thirdly, the new-type water cooling device timely dissipates the inner heat of the transformer so that the temperature rise of the cooling device is depressed and service life of components inside the transformer, such as rectifier diode and magnetic core, is extended. The temperature of the magnetic core is controlled within 60° C. and that of the rectifier diode is controlled within 80° C. The system has a temperature sensor monitor to ensure that the transformer bulk temperature decreases substantially and the output current fluctuates in a small range. Therefore, the influence of temperature rise on the transformer is reduced.

Fourthly, this invention creatively uses rubber tubes and self-locking connectors to connect passages and conduits of the cooling device to narrow the interspaces inside the transformer where the waterways get connected. Thereby the transformer size is somewhat reduced and the waterway connection tightness is ensured at the same time.

Fifthly, the present invention creatively uses a secondary coil winded with a red copper pipe for the transformer, and connects the cooling water in the pipe to cooling water passages at other parts of the transformer. It saves the space for mounting a cooling pipe on the secondary coil and has a great cooling effect.

### BRIEF DESCRIPTION OF DRAWINGS

FIG. 1 is a structure diagram of the fully assembled water cooling transformer and cooling device according to this invention.

FIG. 2 is a diagram showing positions of waterway interfaces of the cooling device according to this invention.

FIG. 3 is a diagram showing the water flow of the water cooling device according to this invention.

FIG. 4 is a structure diagram of the left transformer secondary and its lead plate according to this invention.

FIG. 5 is a structure diagram of the right transformer secondary and its lead plate according to this invention.

FIG. 6 is a structure diagram of the planar rectifier diode according to this invention.

FIG. 7 is a structure diagram of the self-locking connector according to this invention.

### DESCRIPTION OF PREFERRED EMBODIMENT

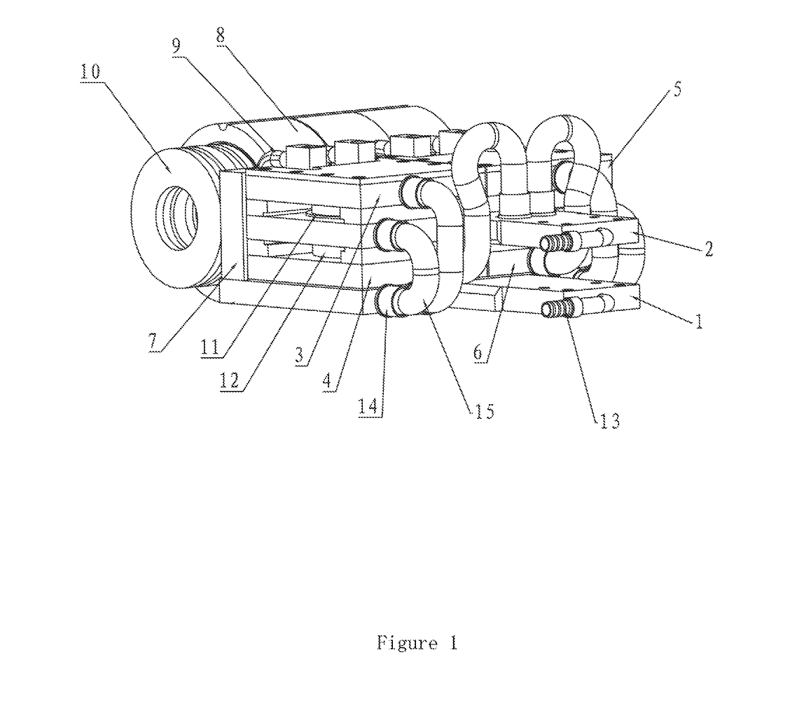

Here is a detailed description with reference to the drawings and the embodiment. FIG. 1 shows a water cooling sub-high frequency transformer and its cooling device, comprising: 1.

rectifier cathode output plate; 2. rectifier anode output plate; 3. upper diode positive lead plate; 5. upper diode positive lead plate; 4. lower diode positive lead plate; 6. lower diode positive lead plate; 7. transformer center tap; 8. transformer magnetic core; 9. transformer diode positive lead terminal; 10. transformer primary coil; 11. planar rectifier diode; 12. planar rectifier diode; 13. self-locking connector; 14. self-lock head; 15. insulating rubber tube.

A water cooling sub-high frequency transformer comprises a primary coil (10), secondary coils (9a1, 9a2, 9b1, 9b2, 9c1, 9c2, 9d1, 9d2), and a rectifier circuit connected with the secondary coils, the rectifier circuit comprising planar rectifier diodes (11, 22), diode positive terminal lead plates (3, 4, 5, 6), a rectifier cathode output plate (1), and a rectifier anode output plate (2), wherein the rectifier cathode output plate is a center tap of the transformer; the secondary current of the transformer is connected to the rectifier anode output plate after being rectified by the planar rectifier diode, and is output by the rectifier anode output plate; and each of the rectifier diode positive lead plate, the rectifier anode output plate and the rectifier cathode output plate employs a red copper plate structure with a certain thickness provided inside with cooling water passages.

The water cooling sub-high frequency transformer comprises two sub transformers connected in parallel, each comprising two groups of primary coils and two groups of secondary coils; each group of primary coils comprises three sub coils, and each group of secondary coils comprises two secondary coils (9a1 and 9a2) each of which has its two ends joined together; the two leads for the respective two ends of each secondary coil are respectively connected to two diode positive terminal lead plates (3, 4) parallel in a vertical direction; the secondary coil center tap terminal (7a) is connected to the rectifier cathode output plate (1) at the joining parts of two secondary coils; the two diode positive terminal lead plates (3, 4) are connected with the positive terminals of the planar rectifier diodes, and the negative terminals are connected with the rectifier anode output plate (2) which, as FIGS. 1, 4 and 5 show, is positioned between the two, upper and lower, diode positive terminal lead plates, the upper planar rectifier diode (11) being positioned between the upper diode positive terminal lead plate and the rectifier anode output plate and the lower planar rectifier diode (12) being positioned between the lower diode positive terminal lead plate and the rectifier anode output plate, so that the two rectifier diodes are tightly pressed (under a pressure of 20000 N/c m²) between three copper plates. In this way, tight contact between the red copper plates and the diodes, as well as efficient transfer of current and heat, can be ensured.

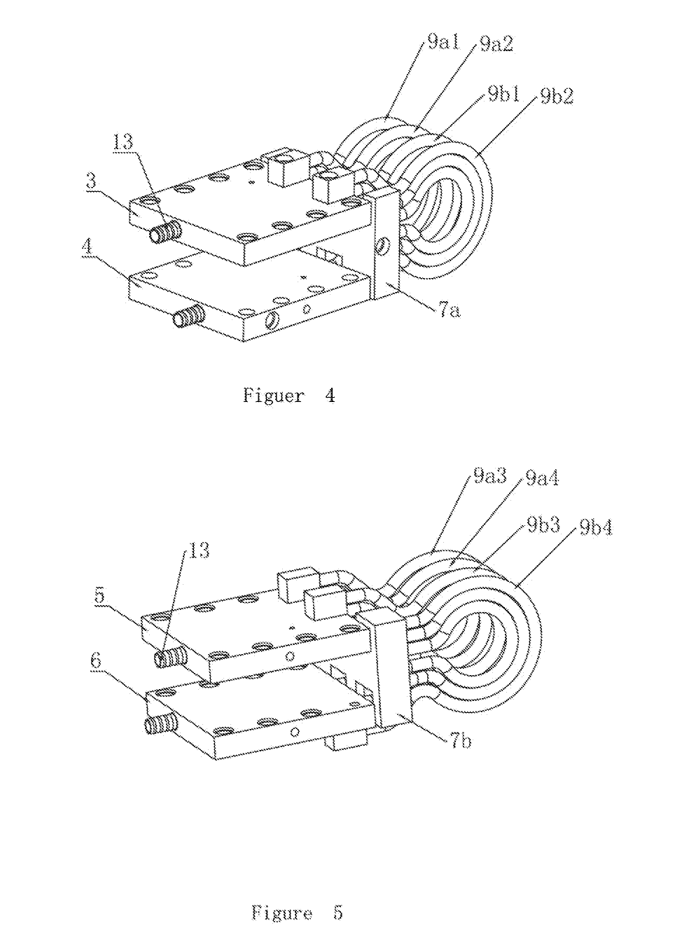

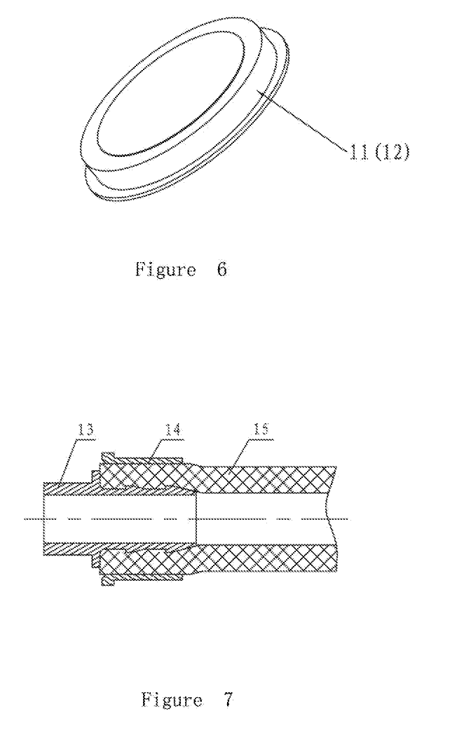

As showed in FIGS. 4 and 5, the secondary coil (9a1, 9a2, 9b1, 9b2, 9c1, 9c2, 9d1, 9d2) is winded with a red copper pipe of a 4˜10 mm diameter in communication with the cooling water passages in the rectifier diode positive lead plate, the rectifier anode output plate and the rectifier cathode output plate.

As showed in FIGS. 4 and 5, the two sub transformers are respectively left transformer secondary and right transformer secondary, wherein the center tap terminal (7a) of the two groups of secondary coils (9a1, 9a2, 9b1, 9b2) of the left transformer is welded to the rectifier cathode output plate (1), and the other four lead terminals are welded to the diode positive terminal lead plates (3, 4); and, the cooling water passages inside the two diode positive terminal lead plates, the red copper pipes composing the secondary coils, and the cooling conduits inside the rectifier cathode output plate are in communication with each other.

As FIG. 5 shows, the center tap terminal (7b) of the two groups of secondary coils (9a3, 9a4, 9b3, 9b4) of the right transformer is welded to the rectifier cathode output plate (1), and the other four lead terminals are welded to the diode positive terminal lead plates (5, 6); and, the cooling water passages inside the two diode positive terminal lead plates, the red copper pipes composing the secondary coils, and the cooling conduits inside the rectifier cathode output plate are in communication with each other.

In FIG. 1, the diode positive terminal lead plates (3, 4, 5, 6), the rectifier cathode output plate (1), and the rectifier anode output plate (2) respectively employ a plate structure made of a red copper plate with a thickness of 10˜15 mm, wherein through holes provided inside each plate structure compose cooling water passages for cooling water circulation flow, and theses cooling water passages communicate with the red copper pipes composing the secondary coils.

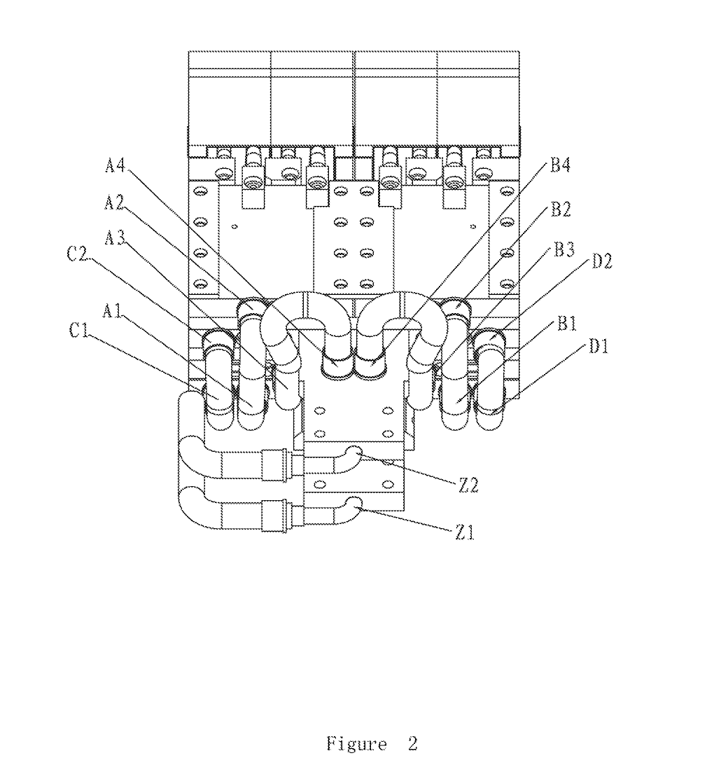

As showed in FIG. 2, a cooling device comprises a water outlet provided on the rectifier anode output plate (Z2), a water inlet provided on the rectifier cathode output plate (Z1), and cooling water passages provided inside the rectifier cathode output plate, the rectifier anode output plate and diode positive terminal lead plate in communication with each other, wherein the rectifier cathode output plate, the rectifier anode output plate and the diode positive terminal lead plate respectively employ a plate structure with a certain thickness, a plurality of through holes are provided inside each of the plate structure to compose cooling water passages for cooling water circulation flow, and theses cooling water passages communicate with red copper pipes that compose transformer secondary coils.

FIG. 2 shows a flow chart of cooling water in the cooling device: the cooling water under 0.3 Mpa pressure flows from the water inlet (Z1) of the rectifier cathode output plate into the rectifier cathode output plate before being separated by the waterways in the rectifier cathode output plate into four branches A, B, C and D in parallel connection, then flows into the rectifier anode output plate, and finally converges to flow out. The four branches connected in parallel flow as follows:

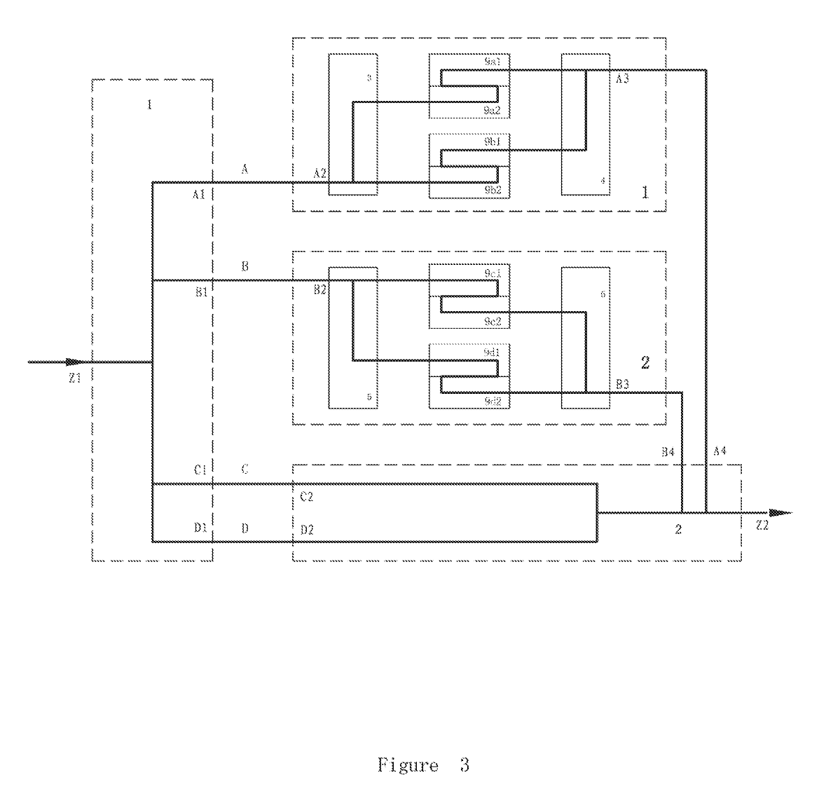

With reference to FIGS. 2 and 3, here is the flow direction of Branch A: it enters a left passage of the rectifier cathode output plate 1 from the inlet (Z1) of the same plate and leaves from its outlet (A1), then flows into the inlet (A2) of the diode positive terminal lead plate 3 and diverges into two streams in the diode positive terminal lead plate 3, one flowing directly into the secondary coils (9b1, 9b2) (to bring away the heat of the secondary and primary coils) then into the diode positive terminal lead plate 4 and flowing through the waterways inside the diode positive terminal lead plate 4 (to bring away the heat of the diode positive terminal lead plate 4) to enter the outlet (A3) of the rectifier anode output plate, the other stream entering the secondary coils (9a1, 9a2) via the waterways in the diode positive terminal lead plate 3 (to bring away part of the heat of the lead plate 3), passing through the secondary coils (to bring away the heat of the secondary coils 9a1 and 9a1 and the primary coils), and flowing into the diode positive terminal lead plate 4 to finally arrive at the outlet (A3) of the rectifier anode plate, then flows into the inlet (A4) of the rectifier anode output plate 2, and finally flows out from the outlet (Z2) of the rectifier anode output plate.

With reference to FIG. 2 and FIG. 3, here is the flow direction of Branch B: it enters a right passage of the rectifier cathode output plate 1 from the inlet (Z1) of the same plate and leaves from its outlet (B1), then flows into the inlet (B2) of the diode positive terminal lead plate 5 and diverges into two streams in the diode positive terminal lead plate 5, one flowing directly into the secondary coils (9c1, 9c2) (to bring away the heat of the secondary and primary coils), then into the diode positive terminal lead plate 6, and flowing through the waterways inside the diode positive terminal lead plate 6 (to bring away part of the heat of the diode positive terminal lead plate 6) to reach the outlet (B3) of the same plate and then into the inlet (A4) of the rectifier anode output plate 2, the other stream entering the secondary coils (9d1, 9d2) via the waterways in the diode positive terminal lead plate 5 (to bring away the heat of the lead plate 5), passing through the secondary coils (to bring away the heat of the secondary and primary coils), and flowing into the diode positive terminal lead plate 6 to reach the outlet (B3) of the same plate and then into the inlet (B4) of the rectifier anode output plate 2, and finally flows out from the outlet (Z2) of the rectifier anode output plate.

With reference to FIG. 2 and FIG. 3, here is the flow direction of Branch C: it enters a left passage of the rectifier cathode output plate 1 from the inlet (Z1) of the same plate and leaves from its outlet (A3), then flows into the inlet (A4) of the rectifier anode output plate 2, and passes through left waterways of the rectifier anode output plate (to bring away the heat of the left rectifier diode positive) to flow out from the outlet (Z2) of the rectifier anode output plate;

With reference to FIG. 2 and FIG. 3, here is the flow direction of Branch C: it enters a right passage of the rectifier cathode output plate 1 from the inlet (Z1) of the same plate and leaves from its outlet (B3), then flows into the inlet (B4) of the rectifier anode output plate 2, and passes through right waterways of the rectifier anode output plate (to bring away the heat of the right rectifier diode positive) to flow out from the outlet (Z2) of the rectifier anode output plate.

As FIGS. 2 and 7 show, in the rectifier, the waterway connections between the rectifier anode plate, the rectifier cathode plate and the diode positive lead, and between the above and the red copper pipes composing the secondary coils are achieved by insulating rubber tubes (with an outer diameter of 13 mm and an inner diameter of 6.5 mm) using a self-locking connector comprising a self-lock head (13) and a self-lock sleeve (14). The engaging part between the self-lock head and the rubber tube (15) is provided with two inverted cone slots with acute angle openings, and a partially engaging cylindrical surface is provided between the slots, the inner diameter of the cylindrical surface being larger than that of the rubber tube by 1.8 mm and the inner diameter of the self-lock sleeve being smaller than the outer diameter of the rubber tube stretched after being inserted into the self-lock head by 0.2 mm.

FIG. 7 shows the assembly of the rubber tube wherein the rubber tube is sleeved on the self-lock head to tightly enwrap the self-lock head, and the cylindrical surface is perfectly engaged to the rubber tuber to ensure the connection tightness. The self-lock sleeve is 0.2 mm smaller than the stretched rubber tube so as to, when being sleeved on the rubber tube stretched to open up, compress the rubber tube to prevent it from expanding outward. Meanwhile, part of the rubber is embedded in the inverted cone slots of the self-lock head to prevent the rubber tube from coming off.

The magnetic core has a temperature controlled under 60° C. and the rectifier diode has a temperature controlled under 80° C. The system has a temperature sensor monitor to ensure that the transformer bulk temperature decreases substantially and the output current fluctuates in a small range. Therefore, the influence of temperature rise on the transformer is reduced.

The present invention narrows the interspaces inside the transformer where the waterways get connected. Thereby the transformer size is somewhat reduced and the waterway connection tightness is ensured at the same time.

The transformer of this invention uses only four planar rectifier diodes to output a current of 12000 A, and has the dimensions of 300 mm*168 mm*100 mm much smaller than a traditional transformer.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims.

1. A water cooling sub-high frequency transformer, comprising a magnetic core, a primary coil, a secondary coil, and a rectifier circuit connected with the secondary coil, characterized in that the rectifier circuit comprises a planar rectifier diode, a diode positive terminal lead plate, a rectifier cathode output plate, and a rectifier anode output plate, wherein the rectifier cathode output plate is a center tap of the transformer; the secondary current of the transformer is connected to the rectifier anode output plate after being rectified by the planar rectifier diode, and is output by the rectifier anode output plate; and each of the rectifier diode positive lead plate, the rectifier anode output plate and the rectifier cathode output plate employs a copper plate structure with a certain thickness provided inside with cooling water passages.

2. The water cooling sub-high frequency transformer according to claim 1, wherein it comprises two sub transformers connected in parallel, each comprising one to three groups of primary coils and one to three groups of secondary coils; each group of primary coils comprises three sub coils, and each group of secondary coils comprises two secondary coils each of which has its two ends joined together; the two leads for the respective two ends of each secondary coil are respectively connected to two diode positive terminal lead plates parallel in a vertical direction; the secondary coil center tap terminal is connected to the rectifier cathode output plate at the joining parts of the two secondary coils; the two diode positive terminal lead plates are connected with the positive terminals of the planar rectifier diodes, and the negative terminals are connected with the rectifier anode output plate positioned between the two diode positive terminal lead plates, one planar rectifier diode being positioned between the upper diode positive terminal lead plate and the rectifier anode output plate, and the other planar rectifier diode being positioned between the lower diode positive terminal lead plate and the rectifier anode output plate, so that the two planar rectifier diodes are tightly pressed between three copper plates of the two diode positive terminal lead plates and the rectifier anode output plate.

3. The water cooling sub-high frequency transformer according to claim 1, wherein the secondary coil is winded with a red copper pipe of a 4˜10 mm diameter in communication with the cooling water passages in the rectifier diode positive lead plate, the rectifier anode output plate and the rectifier cathode output plate.

4. The water cooling sub-high frequency transformer according to claim 2, characterized in that the secondary coil center tap terminal of the sub transformer is welded to the rectifier cathode output plate, wherein two output terminals are welded to the upper diode positive terminal lead plate and the other two output terminals are welded to the lower diode positive terminal lead plate.

5. The water cooling sub-high frequency transformer according to claim 2, characterized in that the diode positive terminal lead plate, the rectifier cathode output plate and the rectifier anode output plate respectively employ a plate structure made of a red copper plate with a thickness of 10˜15 mm, wherein through holes provided within the plate structure compose cooling water passages for cooling water circulation flow, and theses cooling water passages communicate with the red copper pipes composing the secondary coils.

6. A cooling device comprising a water outlet, a water inlet and cooling water passages in communication with each other, characterized in that the water inlet is provided on the rectifier cathode output plate, the water outlet is provided on the rectifier anode output plate, and the cooling water passages are provided inside the rectifier cathode output plate, the rectifier anode output plate and diode positive terminal lead plate, wherein the rectifier cathode output plate, the rectifier anode output plate and the diode positive terminal lead plate respectively employ a plate structure with a certain thickness, a plurality of through holes are provided inside each of the plate structure to compose cooling water passages for cooling water circulation flow, and theses cooling water passages communicate with red copper pipes that compose transformer secondary coils.

7. The cooling device according to claim 6, characterized by a water cooling workflow of the cooling device in which the cooling water flows from the water inlet on the rectifier cathode output plate into the cooling water passages on the rectifier cathode plate before diverging into three to six streams: two of the separated streams flow out of the cooling water passages on the rectifier cathode plate to enter the cooling water passages on the rectifier anode output plate and then converge at the outlet of the same plate; and the rest of streams flow out of the cooling water passages on the rectifier cathode plate to enter one group of the cooling water passages on the planar rectifier diode positive plate, get into another group of the cooling water passages on the planar rectifier diode positive plate after separating two of them to get into two or three secondary coils, and afterwards flow into the cooling water passages on the rectifier anode output plate to finally converge at the water outlet on the rectifier anode output plate.

8. The cooling device according to claim 6, characterized by a water cooling workflow of the cooling device, in which the cooling water flows from the water inlet on the rectifier cathode output plate into the cooling water passages on the rectifier cathode output plate before being separated by said passages into four branches A, B, C and D in parallel connection, then flow into the cooling water passages on the rectifier anode output plate, and converge at the water outlet on the rectifier anode output plate to flow out.

9. The cooling device according to claim 6, wherein the water passages and conduits in the water cooling device are connected with each other by an insulating rubber tube with a self-locking connector comprising a self-lock head and a self-lock sleeve, the engaging part between the self-lock head and the rubber tube being provided with two inverted cone slots with acute angle openings, and a partially engaging cylindrical surface provided between the slots having an inner diameter larger than that of the rubber tube.

10. The water cooling sub-high frequency transformer according to claim 2, wherein the secondary coil is winded with a red copper pipe of a 4˜10 mm diameter in communication with the cooling water passages in the rectifier diode positive lead plate, the rectifier anode output plate and the rectifier cathode output plate.

11. The water cooling sub-high frequency transformer according to claim 3, characterized in that the secondary coil center tap terminal of the sub transformer is welded to the rectifier cathode output plate, wherein two output terminals are welded to the upper diode positive terminal lead plate and the other two output terminals are welded to the lower diode positive terminal lead plate.

12. The water cooling sub-high frequency transformer according to claim 3, characterized in that the diode positive terminal lead plate, the rectifier cathode output plate and the rectifier anode output plate respectively employ a plate structure made of a red copper plate with a thickness of 10˜15 mm, wherein through holes provided within the plate structure compose cooling water passages for cooling water circulation flow, and theses cooling water passages communicate with the red copper pipes composing the secondary coils.
